(19) United States
(12) Patent Application Publication
(10) Pub. No.: US 2015/0017567 A1
(43) Pub. Date: Jan. 15, 2015

(54) ELECTROCHEMICAL ENERGY STORAGE DEVICE OR ENERGY CONVERSION DEVICE COMPRISING A GALVANIC CELL HAVING ELECTROCHEMICAL HALF-CELLS CONTAINING A SUSPENSION OR FULLERENE AND IONIC LIQUID

(71) Applicant: Fraunhofer-Gesellschaft zur Forderung der angewandten Forschung e.V., Munich (DE)

(72) Inventors: Jens Noack, Pfinztal (DE); Jens Tuebke, Waldbronn (DE); Karsten Pinkwart, Pfinztal (DE)

(21) Appl. No.: 14/381,906

(22) PCT Filed: Feb. 28, 2013
(86) PCT No.: PCT/EP2013/054092

§ 371 Date: Aug. 28, 2014

(30) Foreign Application Priority Data
Mar. 1, 2012 (DE) 102012203194.4

(51) Int. Cl. H01M 8/22; H01M 8/20; H01M 8/18

(52) U.S. Cl. CPC H01M 8/225; H01M 8/188; H01M 8/20
USPC 429/498

(57) ABSTRACT

An electrochemical half-cell, comprising an active anode and/or cathode material having at least one fullerene.

The present invention relates to an electrochemical half-cell comprising an active anode and/or cathode material having at least one fullerene as well as to an electrochemical half-cell comprising a suspension having at least one fullerene and at least one ionic liquid.

The invention relates further to an electrochemical energy storage and/or energy conversion device having at least two of the electrochemical half-cells of the invention, and to a method for producing an electrochemical half-cell of the invention, comprising the provision of a suspension having at least one fullerene.

### BACKGROUND OF THE INVENTION

Energy storage devices and/or energy conversion devices comprise galvanic cells, in which chemical energy is converted into electrical energy by redox reactions on the electrodes. A galvanic cell is used as a DC voltage source and comprises at least two electrochemical half-cells in which oxidation and reduction occur separately from each other. Galvanic cells are systematically divided into three groups:
(a) Primary cells, which are also referred to as battery, characterized in that after connecting of the half-cells with at least one electron conductor and at least one ion conductor, the cell is charged and can be discharged once. The redox reaction on which the discharge is based on is irreversible, so that the primary cell cannot be electrically charged again.
(b) Secondary cells, which are also referred to as accumulator, characterized in that they form a galvanic cell from at least one electron conductor and at least one ion conductor connected half-cells, which can be repeatedly charged and discharged. The redox reaction on which the discharge is based on is reversible, so that the secondary cells may be electrically charged. The life span of the secondary cell is thereby limited by a certain number of charging and discharging processes.
(c) Fuel cells, which are also referred to as tertiary cells, characterized in that the chemical energy carrier is not stored in the cell, but is continuously supplied externally. Thus, a fuel cell utilizes the chemical energy of a continuously supplied fuel and of a continuously supplied oxidizing agent and converts these into electrical energy.

Commercial secondary cells are, for example, lead-acid accumulators, nickel-cadmium accumulators, nickel-metal hydride accumulators, nickel-zinc accumulators, nickel-iron accumulators, lithium-ion accumulators, lithium-polymer accumulators, lithium-iron accumulators, lithium-manganese accumulators, lithium-iron-phosphate accumulators, lithium-sulfur accumulators and lithium-titanate accumulators.

Lead-acid accumulators comprise aqueous sulfuric acid as the electrolyte, and have a gravimetric energy density of 30 Wh/kg at a nominal voltage of 2.0 V. Accumulators based on nickel comprise aqueous alkali metal hydroxides as the electrolyte, and have a gravimetric energy density in the range of from 40 to 110 Wh/kg at a nominal voltage in a range of from 1.2 to 1.9 V. Accumulators based on lithium comprise anhydrous organic solvents containing lithium salts, as well as a molten salts as the electrolyte, have a gravimetric energy density in the range of from 70 to 210 Wh/kg at a nominal voltage in a range of from 2.2 to 3.7 V. Accumulators based on lithium, especially lithium-polymer accumulators have a high energy density, but they usually show distinct aging and contain highly flammable active anode and/or cathode materials, representing a great danger potential, especially when used in the private sector.

In general, high nominal voltages as well as high capacities are sought at a high gravimetric and volumetric energy density. This is of particular importance in mobile applications, such as the mobile sector.

The gravimetric energy density (E_{grav}) and the volumetric energy density (Eᵥₒₗ) of a galvanic cell become apparent from formulae (i) and (ii):

E_{grav}[Wh/kg]=U[V]·I[A]·t[h]/m[kg] (i),

Eᵥₒₗ[Wh/cm³]=U[V]·I[A]·t[h]/V[cm³] (ii),

wherein U represents voltage in volt [V], I represents current in ampere [A], t represents time in hours [h], m represents mass in kilogram [kg] and V represents volume in cubic centimeter [cm³].

High gravimetric and volumetric energy densities are therefore achieved when galvanic cells are constructed from materials having a high performance and a low molar mass and/or a low molar volume. Accordingly, there is a need for new materials for the construction of galvanic cells having a high efficiency, which have a high gravimetric and/or volumetric energy density.

In this context, the choice of the electrolyte used in the galvanic cell and of the solvents used in the galvanic cell is of particular importance, since the conventionally employed aqueous electrolytes and solvents are not stable at high voltages. Therefore, there is a need for non-aqueous electrolyte compounds and solvents, which are stable at high voltages.

In the above-mentioned already known from the prior art and commercially available secondary cells, rare and expensive metal-containing compounds are used as active anode and/or cathode materials. This results in a production of secondary cells constructed therefrom, that is very expensive. Due to the increasing demand and the associated market price pressure among market participants, there is, therefore, a very significant need for new active anode and/or cathode materials, in particular active anode and/or cathode materials which are not based on metals, metal ions and/or metal compounds, in particular not on metals, metal ions and/or metal compounds of lead, nickel, cadmium, lithium, manganese, titanium or zinc.

By “active anode and/or cathode materials”, electrochemically active compounds are to be understood, which absorb or emit electrons on an electrode by chemical conversions, in particular reduction or oxidation processes.

### SUMMARY OF THE INVENTION

An object of the present invention is to provide an electrochemical half-cell as well as an energy storage and/or energy conversion device having at least two of the electrochemical half-cells of the invention, comprising active anode and cathode materials without metals, metal ions and/or metal compounds. Of particular interest are energy storage and/or energy conversion devices with improved gravimetric and/or volumetric energy density.

A further object of the present invention is to provide a suitable electrolyte for the production of an electrochemical half-cell of the invention as well as an energy storage and/or energy conversion device of the invention, having a low vapor pressure, high thermal and chemical stability as well as high electric conductivity and a broad electrochemical window, which has a high flash point compared to the conventional anhydrous organic solvents used in commercial energy storage and/or energy conversion devices.

By “energy storage and/or energy conversion device”, a device comprising anodes and cathodes to spontaneously convert chemical into electrical energy is to be understood. The anode and the cathode are both electrolytically as well as in electrical contact. The power-generating reactions are redox reactions, their electromotive forces are predetermined by the standard potentials of the involved chemical elements. The electromotive force is to be understood as the potential difference between the clamps of an electrical power source, which does not supply power. The standard potential of an electrode is the equilibrium value of the electrode potential when the participating components in the electrode reaction of the electrolyte are in a standard state and the solid components are present in a pure form, whereby the standard state is set by a standard temperature of 273.1 K and a standard pressure of 1.01325 bar. For dissolved electrolytes, the specific concentration corresponding to the standard state is the normality. The standard potential corresponds to the potential of a standard metal electrode, i.e., a metal electrode, which is immersed into the solution of one of its salts of the activity 1, against the standard hydrogen electrode at 25° C.; c.f. Rompp Chemie Lexikon, 9^{th} Edition, pages 1123, 1476 to 1477 and 3048 to 3051. The electrochemical energy storage and/or energy conversion device with at least two electrochemical half-cells as designated device within the scope of this invention essentially corresponds to a galvanic cell.

By “electrochemical half-cell”, an arrangement is to be understood, whereby the active anode and/or cathode material as well as the electrode is immersed in an electrolyte, whereby the electrolyte is in contact with the electrolyte of at least one further “electrochemical half-cell”, in particular through a porous diaphragm (microporous separator).

These objects are solved by the features of the independent claims, advantageous embodiments of the invention are specified in the dependent claims.

The invention relates to electrochemical half-cells comprising an active anode and/or cathode material having at least one fullerene as well as to electrochemical half-cells comprising a suspension having at least one fullerene and at least one ionic liquid.

The invention relates further to an electrochemical energy storage and/or energy conversion device having at least two of the electrochemical half-cells of the invention, and to a method for producing an electrochemical half-cell of the invention, in particular a method for producing an electrochemical half-cell comprising the provision of an active anode and/or cathode material having a least one fullerene.

### DETAILED DESCRIPTION OF THE INVENTION

The invention relates to an electrochemical half-cell comprising an active anode and/or cathode material having at least one fullerene as well as to an electrochemical half-cell comprising a suspension having at least one fullerene and at least one ionic liquid.

By “fullerene”, in the context of this invention, are to be understood spherical macromolecules from C₂ₙ carbon atoms, solely consisting of carbon, having pentagonal and hexagonal structural units of high symmetry, which represents a further modification of the chemical element carbon, alongside to diamond, graphite, carbon nanotubes, and graphene.

By “ionic liquid”, in the context of this invention, is to be understood liquids which consist solely of ions. To distinguish from classical molten salts, only such salts are referred to as ionic liquids, which have a melting point below 100° C.; c.f. P. Water, W. Keim, Angewandte Chemie, International Edition 2000, 39, 3772. Ionic liquids are usually classified by their type of cation, whereby typical representatives are based on imidazolium, pyridinium, ammonium and/or phosphonium salts. In general, ionic liquids have a low vapor pressure, high thermal and chemical stability as well as a high electric conductivity and a broad electrochemical window. In addition, the ionic liquids are characterized by a high flash point compared to usual organic solvents.

The fullerene is preferably selected from a group consisting of [5,6]-fullerene-C₆₀ (IUPAC: C₆₀-Iₕ)[5,6]fullerene), [5,6]-fullerene-C₇₀ (IUPAC: (C₇₀-D_{5b(6)})[5,6]fullerene), fullerene-C₇₆, fullerene-C₇₈, fullerene-C₈₀, fullerene-C₈₂, fullerene-C₈₄, fullerene-C₈₆, fullerene-C₉₀ or mixtures thereof, particular preferred [5,6]-fullerene-C₆₀ and/or [5,6]-fullerene-C₇₀, in particular [5,6]-fullerene-C₆₀.

The ionic liquid is preferably selected from a group consisting of 1-butyl-3-methyl-imidazolium-chloride, 1-butyl-3-methyl-imidazolium-hexafluorphosphate, 1-butyl-3-methyl-imidazolium-tetrafluorborate, 1-butyl-3-methyl-imidazolium-trifluormethanesulfonate, 1-butyl-1-methyl-pyrrolidinium-bis(trifluoromethylsulfonyl)imide, butyl-trimethylammonium-bis(trifluoromethylsulfonyl)imide, cholin-dihydrogenphosphate, ethylammoniumnitrate, 1-ethyl-3-methyl-imidazolium-bromide, 1-ethyl-3-methyl-imidazolium-dicyanamide, 1-ethyl-3-methyl-imidazolium-ethylsulfate, 1-ethyl-3-methyl-imidazolium-methanesulfonate, 1-hexyl-3-methyl-imidazoliumchloride, 1-hexyl-3-methyl-imidazolium-hexafluorophosphate, 1-hexyl-3-methyl-imidazolium-tetrafluoroborate, 1-methyl-3-octyl-imidazolium-hexafluorophosphate, 1-methyl-3-octyl-imidazolium-tetrafluoroborate, 1-methyl-3-propyl-imidazolium-iodide, 1-methyl-1-propyl-piperidinium-bis-(trifluoromethylsulfonyl)-imide, triethylsulphonium-bis(trifluoromethylsulfonyl)imide or mixtures thereof, in particular 1-methyl-1-propylpyrrolidiniumbis(trisfluoromethylsulfonyl)imide.

In an advantageous embodiment of the invention, the electrochemical half-cell comprises at least one active anode and/or cathode material, at least one electrolyte and at least one electrode.

Active Anode and/or Cathode Material

The active anode material comprises an electrochemically active compound which can absorb and/or emit at least 1 electron, preferably at least 2 electrons, more preferably at least 3 electrons, more preferably at least 4 electrons, more preferably at least 5 electrons, more preferably at least 6 electrons, more preferably up to 2 electrons, more preferably up to 3 electrons, more preferably up to 4 electrons, more preferably up to 5 electrons, more preferably up to 6 electrons. The active cathode material, in this case, comprises an electrochemically active compound which can absorb and/or emit at least 1 electron, preferably at least 2 electrons, more preferably at least 3 electrons, more preferably at least 4 electrons, more preferably at least 5 electrons, more preferably at least 6 electrons, more preferably up to 2 electrons, more preferably up to 3 electrons, more preferably up to 4 electrons, more preferably up to 5 electrons, more preferably up to 6 electrons. The absorption or emission of electrons by the active anode and/or cathode material occurs by reduction or oxidation processes.

In one embodiment, the active anode and/or cathode material comprises at least one fullerene. In a particular embodiment, the fullerene is the only component of the active anode and/or cathode material.

Fullerene can be present as multiple charged cation or multiple charged anion, in particular, the fullerene can be present in oxidized form in the oxidation states +1 to +6 and in reduced form in the oxidation states −1 to −6. In other words, the fullerene can, in its electronic ground state, absorb up to 6 electrons or emit up to 6 electrons. The fullerene can be present in solid and/or dissolved form, in particular in the form of particles.

In a particular embodiment of the electrochemical half-cell of the invention, the active anode and/or cathode material comprises in addition to at least one fullerene no other active anode and/or cathode materials. In other words, in this embodiment, the fullerene is the only active anode and/or cathode material. The electrochemical half-cell of the invention preferably comprises an active anode and/or cathode material which is free of metals, metal ions and/or metal compounds.

In a further particular embodiment of the electrochemical half-cell of the invention, the active anode and/or cathode material comprises at least one fullerene which is present in the form of a suspension. The suspension may comprise 0.1 to 99.9 wt.-%, preferably 1 to 50 wt.-%, more preferably 1 to 25 wt.-%, more preferably 5 to 20 wt.-%, in particular 10 wt.-% fullerene, based on the total weight of the suspension.

Therefore, in context of this invention, electrochemical half-cells comprising an active anode and/or cathode material having at least one fullerene are described, wherein in one embodiment of the electrochemical half-cell of the invention, the active anode and/or cathode material having at least one fullerene is present in the form of a suspension. In a preferred embodiment of the electrochemical half-cell of the invention, the active anode and/or cathode material having at least one fullerene is present in the form of a suspension having at least one ionic liquid.

In a further embodiment, the fullerene is present in the form of a suspension having an electrolyte, in particular having an electrolyte comprising an ionic liquid. In a preferred embodiment, the electrolyte represents the solvent used to form the suspension.

In a further particular embodiment, the electrochemical half-cell of the invention comprises an anode and/or cathode material having an active anode and/or cathode material. The anode and/or cathode material may comprise a carrier material in addition to the active anode and/or cathode material. By “carrier material”, a material is to be understood that is coated with the active anode and/or cathode material, or in which the active anode and/or cathode material is dispersed, but which differs from the active anode and/or cathode material. In one embodiment, the carrier material does not have an electrochemical activity, in particular no electrochemical activity and no electrical conductivity.

The electrolyte comprises an ionically conductive medium, of which the electrical conductivity is established through an electrolytic dissociation into ions. In a particular embodiment of the electrochemical half-cell of the invention, the electrolyte comprises an ionic liquid, in particular an ionic liquid selected from the group consisting of 1-butyl-3-methyl-imidazolium-chloride, 1-butyl-3-methyl-imidazolium-hexafluorophosphate, 1-butyl-3-methyl-imidazolium-tetrafluoroborate, 1-butyl-3-methyl-imidazolium-trifluoromethansulfonate, 1-butyl-1-methyl-pyrrolidinium-bis(trifluoromethylsulfonyl)imide, butyl-trimethylammonium-bis(trifluoromethylsulfonyl)imide, cholin-dihydrogenphosphate, ethylammoniumnitrate, 1-ethyl-3-methyl-imidazolium-bromide, 1-ethyl-3-methyl-imidazolium-dicyanamide, 1-ethyl-3-methyl-imidazolium-ethylsulfate, 1-ethyl-3-methyl-imidazolium-methanesulfonate, 1-hexyl-3-methyl-imidazoliumchloride, 1-hexyl-3-methyl-imidazolium-hexafluorophosphate, 1-hexyl-3-methyl-imidazolium-tetrafluoroborate, 1-methyl-3-octyl-imidazolium-hexafluorophosphate, 1-methyl-3-octyl-imidazolium-tetrafluoroborate, 1-methyl-3-propyl-imidazolium-iodide, 1-methyl-1-propyl-piperidinium-bis-(trifluoromethylsulfonyl)-imide, triethylsulphonium-bis(trifluoromethylsulfonyl)imide or mixtures thereof, in particular 1-methyl-1-propylpyrrolidiniumbis(trisfluoromethylsulfonyl)-imide.

The electrode of the electrochemical half-cell of the invention comprises an electron-conducting material, which is in contact with the electrolyte. In one embodiment of the invention, the electrode itself does not comprise the active anode and/or cathode material. The electrode of the electrochemical half-cell of the invention is neither reduced nor oxidized, but serves as an electron conductor. In other words, the reduction and oxidation processes of the active anode and/or cathode material may occur on the electrode without the active anode and/or cathode material being itself part of the electrode.

In a particular embodiment, the electrode comprises at least one carbonaceous material. In a further particular embodiment, the carbonaceous material comprises sheets, in particular carbon fibers and/or carbon particles and/or carbon plates and/or carbon nanotubes. In a further particular embodiment, the sheets comprise woven or non-woven fabric sheets containing carbon fibers, in particular, carbon felt and/or carbon fabric.

In an advantageous embodiment of the invention, the electrochemical half-cell comprises at least one active anode and/or cathode material having at least one fullerene, in particular [5,6]-fullerene-C₆₀, at least one electrolyte having at least one ionic liquid, in particular 1-methyl-1-propylpyrrolidiniumbis(trisfluoromethylsulfonyl)imide, and at least one electrode, in particular a graphite plate and/or a graphite pencil and/or graphite felt and/or graphite fabric.

Electrochemical Half-Cell with Suspension

In another particular embodiment, the electrochemical half-cell of the invention comprises a suspension having at least one fullerene and at least one ionic liquid. The suspension may comprise 0.1 to 99.9 wt.-%, preferably 1 to 50 wt.-%, more preferably 1 to 25 wt.-%, more preferably 5 to 20 wt.-%, in particular 10 wt.-% fullerene, based on the total weight of the suspension. The suspension may comprise 99.9 to 0.1 wt.-%, preferably 99 to 50 wt.-%, more preferably 99 to 75 wt.-%, more preferably 95 to 80 wt.-%, in particular 90% wt.-% ionic liquid, based on the total weight of the suspension. In the context of the present invention, also embodiments are included having a suspension, which has in addition to the fullerene and the ionic liquid further ingredients.

In one embodiment, the active anode and/or cathode material comprises an electrochemically active compound which can absorb and/or emit at least 1 electron, preferably at least 2 electrons, more preferably at least 3 electrons, more preferably at least 4 electrons, more preferably at least 5 electrons, more preferably at least 6 electrons.

In one embodiment, the active anode and/or cathode material comprises an electrochemically active compound which can absorb and/or emit 1 electron, preferably up to 2 electrons, more preferably up to 3 electrons, more preferably up to 4 electrons, more preferably up to 5 electrons, more preferably up to 6 electrons.

The fullerene of the electrochemical half-cell of the invention comprising at least one fullerene and at least one ionic liquid, is in particular a component of the active anode and/or cathode material. Fullerene may be present as multiple charged cation or multiple charged anion, in particular, the fullerene may be present in oxidized form in the oxidation states +1 to +6 and in reduced form in the oxidation states −1 to −6. In other words, the fullerene may, in its electronic ground state, absorb up to 6 electrons or emit up to 6 electrons. The fullerene may be present in solid and/or dissolved form, in particular in the form of particles.

In a particular embodiment of the electrochemical half-cell of the invention comprising at least one fullerene and at least one ionic liquid, the fullerene is the only component of the active anode and/or cathode material.

In a further particular embodiment, the electrochemical half-cell of the invention having at least one fullerene and at least one ionic liquid, comprises an anode and/or cathode material having an active anode and/or cathode material. The anode and/or cathode material may comprise a carrier material in addition to the active anode and/or cathode material. By “carrier material”, a material is to be understood that is coated with the active anode and/or cathode material, or in which the active anode and/or cathode material is dispersed, but which differs from the active anode and/or cathode material. In one embodiment, the carrier material does not have an electrochemical activity, in particular no electrochemical activity and no electrical conductivity.

One embodiment of the electrochemical half-cell of the invention having at least one fullerene and at least one ionic liquid, comprises an electrolyte. The electrolyte comprises an ionically conductive medium, of which the electrical conductivity is established through an electrolytic dissociation into ions. In a particular embodiment of the electrochemical half-cell of the invention, the electrolyte comprises an ionic liquid, in particular an ionic liquid selected from the group consisting of 1-butyl-3-methyl-imidazolium-chloride, 1-butyl-3-methyl-imidazolium-hexafluorophosphate, 1-butyl-3-methyl-imidazolium-tetrafluoroborate, 1-butyl-3-methyl-imidazolium-trifluoromethansulfonate, 1-butyl-1-methyl-pyrrolidinium-bis(trifluoromethylsulfonyl)imide, butyl-trimethylammonium-bis(trifluoromethylsulfonyl)imide, cholin-dihydrogenphosphate, ethylammoniumnitrate, 1-ethyl-3-methyl-imidazolium-bromide, 1-ethyl-3-methyl-imidazolium-dicyanamide, 1-ethyl-3-methyl-imidazolium-ethylsulfate, 1-ethyl-3-methyl-imidazolium-methanesulfonate, 1-hexyl-3-methyl-imidazoliumchloride, 1-hexyl-3-methyl-imidazolium-hexafluorophosphate, 1-hexyl-3-methyl-imidazolium-tetrafluoroborate, 1-methyl-3-octyl-imidazolium-1-methyl-3-octyl-imidazolium-tetrafluoroborate, 1-methyl-3-propyl-imidazolium-iodide, 1-methyl-1-propyl-piperidinium-bis-(trifluoromethylsulfonyl)-imide, triethylsulphonium-bis(trifluoromethylsulfonyl)imide or mixtures thereof, in particular 1-methyl-1-propylpyrrolidiniumbis(trisfluoromethylsulfonyl)-imide.

In a further embodiment, the fullerene is present in the form of a suspension having an electrolyte, in particular having an electrolyte comprising an ionic liquid. In a preferred embodiment, the electrolyte represents the solvent used to form the suspension.

One embodiment of the electrochemical half-cell of the invention having at least one fullerene and at least one ionic liquid, comprises an electrode. The electrode comprises an electron-conducting material, which is in contact with the electrolyte. In one particular embodiment of the invention, the electrode itself does not comprise the fullerene. The electrode of the electrochemical half-cell of the invention is neither reduced nor oxidized, but serves as an electron conductor. In other words, the reduction and oxidation processes of the active anode and/or cathode material may occur on the electrode without the active anode and/or cathode material being itself part of the electrode.

In a particular embodiment, the electrode comprises at least one carbonaceous material. In a further particular embodiment, the carbonaceous material comprises sheets, in particular carbon fibers and/or carbon particles and/or carbon plates and/or carbon nanotubes. In a further particular embodiment, the sheets comprise woven or non-woven fabric sheets containing carbon fibers, in particular, carbon felt, and/or carbon fabric.

An advantageous embodiment of the electrochemical half-cell of the invention having at least one fullerene and at least one ionic liquid, comprises at least one active anode and/or cathode material having at least one fullerene, in particular [5,6]-fullerene-C₆₀, at least one electrolyte having at least one ionic liquid, in particular 1-methyl-1-propylpyrrolidiniumbis(trisfluoromethylsulfonyl)imide, and at least one electrode, in particular a graphite plate and/or a graphite pencil and/or graphite felt and/or graphite fabric.

Energy Storage and/or Energy Conversion Device

The invention further comprises an electrochemical energy storage and/or energy conversion device having at least two of the electrochemical half-cells of the invention.

In a particular embodiment, the electrochemical energy storage and/or energy conversion device comprises at least two of the electrochemical half-cells, wherein
(i) a first electrochemical half-cell includes
   (a) an active anode material
   (b) a first electrolyte and
   (c) a first electrode,
and
(ii) a second electrochemical half-cell includes
   (a) an active cathode material
   (b) a second electrolyte and
   (c) a second electrode,
and
(iii) the electrolyte of the first electrochemical half-cell and the electrolyte of the second electrochemical half-cell are in contact via a separator, in particular a microporous separator,
and
(iv) the first electrochemical half-cell and/or the second electrochemical half-cell include independently from each other, an active anode and/or cathode material, which comprises at least one fullerene.

The active anode and/or cathode material of the first and/or the second electrochemical half-cell comprises an electrochemically active compound, which can absorb and/or emit at least 1 electron, preferably at least 2 electrons, more preferably at least 3 electrons, more preferably at least 4 electrons, more preferably at least 5 electrons, more preferably at least 6 electrons. The absorption or emission of electrons by the active anode and/or cathode material occurs by reduction or oxidation processes.

In one embodiment, the active anode and/or cathode material of the first and/or the second electrochemical half-cell comprises an electrochemically active compound, which can absorb and/or emit at least 1 electron, preferably up to 2 electrons, more preferably up to 3 electrons, more preferably up to 4 electrons, more preferably up to 5 electrons, more preferably up to 6 electrons. The absorption or emission of electrons by the active anode and/or cathode material occurs by reduction or oxidation processes.

In one embodiment, the active anode and/or cathode material of the first and/or the second electrochemical half-cell of the electrochemical energy storage and/or energy conversion device comprises at least on fullerene.

Fullerene can be present as multiple charged cation or multiple charged anion, in particular, the fullerene can be present in oxidized form in the oxidation states +1 to +6 and in reduced form in the oxidation states −1 to −6. In other words, the fullerene can, in its electronic ground state, absorb up to 6 electrons or emit up to 6 electrons. The fullerene can be present in solid and/or dissolved form, in particular in the form of particles.

In a particular embodiment, the fullerene is the only component of the active anode and/or cathode material of the first and/or the second electrochemical half-cell of the electrochemical energy storage and/or energy conversion device of the invention. In a further particular embodiment of the energy storage and/or energy conversion device of the invention, the active anode and cathode material of the first and the second electrochemical half-cell comprises at least one fullerene, whereby the active anode material and the active cathode material of the first and the second electrochemical half-cell are identical.

The first and/or the second electrochemical half-cells of the invention preferably comprise an active anode and/or cathode material which is free of metals, metal ions and/or metal compounds.

In one embodiment of the first and/or the second electrochemical half-cell, the active anode and/or cathode material comprises at least one fullerene, which is present in the form of a suspension, in particular in the form of a suspension having at least one ionic liquid. The suspension may comprise 0.1 to 99.9 wt.-%, preferably 1 to 50 wt.-%, more preferably 1 to 25 wt.-%, more preferably 5 to 20 wt.-%, in particular 10 wt.-% fullerene, based on the total weight of the suspension. In one embodiment having at least one fullerene and at least one ionic liquid, the suspension may comprise 99.9 to 0.1 wt.-%, preferably 99 to 50 wt.-%, more preferably 99 to 75 wt.-%, more preferably 95 to 80 wt.-%, in particular 90 wt.-% ionic liquid, based on the total weight of the suspension.

In a particular embodiment of the energy storage and/or energy conversion device of the invention, the first and the second electrochemical half-cell comprises an active anode and/or cathode material having at least one fullerene, which is present in the form of a suspension, whereby the suspension of the active anode material of the first electrochemical half-cell is identical to the suspension of the active cathode material of the second electrochemical half-cell.

In a further particular embodiment of the energy storage and/or energy conversion device of the invention, the first and the second electrochemical half-cell comprises an active anode and/or cathode material having at least one fullerene, which is present in the form of a suspension having at least one ionic liquid. In a further particular embodiment of the energy storage and/or energy conversion device of the invention, the first and the second electrochemical half-cell comprises an active anode and/or cathode material having at least one fullerene, which is present in the form of a suspension having at least one ionic liquid, whereby the suspension of the active anode material of the first electrochemical half-cell is identical to the suspension of the active cathode material of the second electrochemical half-cell.

In the context of the present invention, also embodiments are included comprising a suspension, which has in addition to the fullerene and the ionic liquid further ingredients.

In a further particular embodiment, the first and/or the second electrochemical half-cell of the invention comprises an anode and/or cathode material having an active anode and/or cathode material. The anode and/or cathode material may comprise a carrier material in addition to the active anode and/or cathode material. By “carrier material”, a material is to be understood that is coated with the active anode and/or cathode material, or in which the active anode and/or cathode material is dispersed, but which differs from the active anode and/or cathode material. In one embodiment, the carrier material does not have an electrochemical activity, in particular no electrochemical activity and no electrical conductivity.

In a further particular embodiment, the fullerene is present in the form of a suspension having an electrolyte, in particular having an electrolyte comprising an ionic liquid. In other words, this embodiment comprises a first and/or a second electrochemical half-cell having an active anode and/or cathode material having at least one fullerene, which is present in the form of a suspension, whereby the suspension comprises also the electrolyte, in particular an ionic liquid.

The first and/or the second electrolyte of the first and/or the second electrochemical half-cell of the energy storage and/or energy conversion device of the invention comprises an ionically conductive medium, of which the electrical conductivity is established through an electrolytic dissociation into ions. In a particular embodiment, the first and/or the second electrolyte comprises an ionic liquid, in particular an ionic liquid selected from the group consisting of 1-butyl-3-methyl-imidazolium-chloride, 1-butyl-3-methyl-imidazolium-hexafluorophosphate, 1-butyl-3-methyl-imidazolium-tetrafluoroborate, 1-butyl-3-methyl-imidazolium-trifluoromethansulfonate, 1-butyl-1-methyl-pyrrolidinium-bis(trifluoromethylsulfonyl)imide, butyl-trimethylammonium-bis(trifluoromethylsulfonyl)imide, cholin-dihydrogenphosphate, ethylammoniumnitrate, 1-ethyl-3-methyl-imidazolium-bromide, 1-ethyl-3-methyl-imidazolium-dicyanamide, 1-ethyl-3-methyl-imidazolium-ethylsulfate, 1-ethyl-3-methyl-imidazolium-methanesulfonate, 1-hexyl-3-methyl-imidazoliumchloride, 1-hexyl-3-methyl-imidazolium-hexafluorophosphate, 1-hexyl-3-methyl-imidazolium-tetrafluoroborate, 1-methyl-3-octyl-imidazolium-hexafluorophosphate, 1-methyl-3-octyl-imidazolium-tetrafluoroborate, 1-methyl-3-propyl-imidazolium-iodide, 1-methyl-1-propyl-piperidinium-bis-(trifluoromethylsulfonyl)-imide, triethylsulphonium-bis(trifluoromethylsulfonyl)imide or mixtures thereof, in particular 1-methyl-1-propylpyrrolidiniumbis(trisfluoromethylsulfonyl)-imide.

In one embodiment of the first and/or the second electrochemical half-cell of the invention, the first and/or the second electrolyte may be identical to the ionic liquid of the active anode and/or cathode material. In a further embodiment of the first and/or the second electrochemical half-cell of the invention, the first electrolyte may be identical to the second electrolyte.

The first and/or the second electrode of the first and/or the second electrochemical half-cell of the energy storage and/or energy conversion device of the invention, comprises an electron-conducting material, which is in contact with the electrolyte. In one embodiment of the invention, the first and/or the second electrode does not comprise the active anode and/or cathode material. The first and/or the second electrode of the energy storage and/or energy conversion device of the invention is neither reduced nor oxidized, but serves as an electron conductor. In other words, the reduction and oxidation processes of the active anode and/or cathode material may occur on the first and/or second electrode without the active anode and/or cathode material being itself part of the first and/or the second electrode.

In a particular embodiment, the first and/or the second electrode comprises at least one carbonaceous material, in particular two carbonaceous materials. In a further particular embodiment, the carbonaceous material comprises sheets, in particular carbon fibers and/or carbon particles and/or carbon plates and/or carbon nanotubes. In a further particular embodiment, the sheets comprise woven or non-woven fabric sheets containing carbon fibers, in particular, carbon felt and/or carbon fabric.

In an advantageous embodiment of the invention, the energy storage and/or energy conversion device of the invention having at least two electrochemical half-cells, comprises at least one active anode and/or cathode material having at least one fullerene, in particular [5,6]-fullerene-C₆₀, at least one electrolyte having at least one ionic liquid, in particular 1-methyl-1-propylpyrrolidiniumbis(trisfluoromethylsulfonyl)imide, and at least a first and a second electrode, in particular graphite plates and/or graphite pencils and/or graphite felts and/or graphite fabrics.

The invention also relates to a method for producing an electrochemical half-cell of the invention, comprising the following method steps:
(i) providing an electrode,
(ii) providing an active anode and/or cathode material having a least one fullerene, in particular in the form of a suspension,
(iii) providing an electrolyte, in particular an electrolyte having at least one ionic liquid.

In one embodiment of the method for producing an electrochemical half-cell of the invention, the electrode is treated with a suspension of the active anode and/or cathode material. Initially, a suspension of the active anode and/or cathode material is prepared, in particular a suspension having at least one fullerene and at least one ionic liquid, and subsequently the electrode is treated with the suspension.

The invention also relates to the use of an electrochemical half-cell of the invention for producing the electrochemical energy storage and/or energy conversion device of the invention.

The electrochemical half-cell of the invention as well as the electrochemical energy storage and/or energy conversion devices having at least two electrochemical half-cells of the invention, are characterized by a particularly high theoretical capacity.

The capacity is the product of current and time, and becomes apparent from formula (iii):

capacity=I·t (iii),

wherein I is the current in ampere [A], t is the time in hours [h].

The capacity of electrochemical half-cells as well as electrochemical energy storage and/or energy conversion devices becomes apparent from the Faraday's law, according to formula (iv):

Q=n·z·F (iv),

wherein Q is the amount of electric charge, n is the converted amount of substance in mol [mol], z is the number of electrons and F is the Faraday constant in coulomb [C] (96487 C).

For a half-cell of the invention as well as the electrochemical energy storage and/or energy conversion device having at least two electrochemical half-cells of the invention, having up to 6 electron transitions, this results in a capacity of 160.8 Ah/mol.

For a half-cell of the invention as well as the electrochemical energy storage and/or energy conversion device having at least two electrochemical half-cells of the invention, having up to 3 electron transitions, this results in a capacity of 80.4 Ah/mol.

For a half-cell of the invention as well as the electrochemical energy storage and/or energy conversion device having at least two electrochemical half-cells of the invention, having up to 2 electron transitions, this results in a capacity of 53.6 Ah/mol.

For a half-cell of the invention as well as the electrochemical energy storage and/or energy conversion device having at least two electrochemical half-cells of the invention, having up to 1 electron transition, this results in a capacity of 26.8 Ah/mol.

For a half-cell of the invention as well as the electrochemical energy storage and/or energy conversion device having at least two electrochemical half-cells of the invention, this results in a theoretically capacity in a range of from of 26.8 to 160.8 Ah/mol.

The energy density is the product of the amount of electric charge and voltage, and becomes apparent from formula (v):

W=Q·U (v),

wherein W is the energy density, Q is the amount of electric charge and U is the voltage.

The energy density of three voltage plateaus with usable reversible redox reactions at 3.5 V, 2.5 V and 1.5 V results according to formula (v) in a theoretical energy density of 201 Wh/mol.

3.5 V·26.8 Ah/mol+2.5 V·26.8 Ah/mol+1.5 V·26.8 Ah/mol=201 Wh/mol

### FIGURES

FIG. 1 shows reduction peaks of [5,6]-fullerene-C₆₀ to [5,6]-fullerene-C₆₀⁻⁶ as disclosed in Q, Xie, E, Perez-Cordero, L'Echegoyen, “Electrochemical Detection of C₆₀⁻⁶ and C₇₀⁻⁶ Enhanced Stability of Fullerides in Solution”, J. Am. Soc., 1992, 114, 3978-3980.

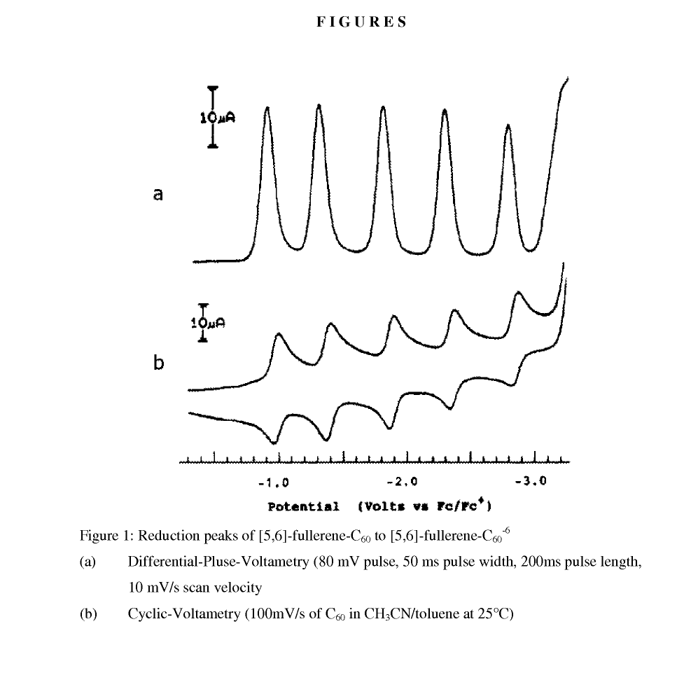

FIG. 2 shows charge and discharge curves of a cell having 10% [5,6]-fullerene-C₆₀ in 1-methyl-1-propylpyrrolidiniumbis(trifluoromethylsulfonyl)imide.

FIG. 3 shows a single charge and discharge curve of a cell having 10% [5,6]-fullerene-C₆₀ in 1-methyl-1-propylpyrrolidiniumbis(trifluoromethylsulfonyl)imide.

### EXAMPLES

### Example 1

An energy storage and/or energy conversion device was constructed from a suspension of 10% [5,6]-fullerene-C₆₀ in 1-methyl-1-propyl-pyrrolidiniumbis(trifluoromethylsulfonyl)imide (99%, Iolitec GmbH, Germany). The energy storage and/or energy conversion device was separated by a microporous separator (Celgard Inc., USA) in two electrochemical half-cells. As electrodes graphite plates (FU 4036, Schunk Kohlenstofftechnik GmbH, Germany) and graphite felt (GFA5, SGL Carbon, Germany) were used. A graphite plate was force-fitted, in particular liquid-tight, single side mounted on PVC frame from four mutually approximately parallel segments with a cavity of 5×33×30 mm Subsequently, a graphite felt was placed in the body, open on one side, and a suspension of 10% [5,6]-fullerene-C₆₀ in 1-methyl-1-propyl-pyrrolidiniumbis(trifluoromethylsulfonyl)imide was applied onto the graphite felt, until it was fully saturated with the suspension and could not take on any further suspension.

The cavity of the on one side open body was filled subsequently with 1-methyl 1-propyl-pyrrolidiniumbis(trifluoromethylsulfonyl)imide, whereby 1-methyl-1-propyl-pyrrolidiniumbis(trifluoromethylsulfonyl)imide acts as the electrolyte. The on one side open body is an embodiment of the electrochemical half-cell of the invention of the electrochemical energy storage and/or energy conversion device. Subsequently, the on one side open body was closed by force-fit, in particular liquid-tight coating of a separator. Then, a second graphite plate was force-fitted, in particular liquid-tight, single side mounted on PVC frame from four mutually approximately parallel segments with a cavity of 5×33×30 mm Subsequently, a second graphite felt was placed in the body, open on two sides, and a suspension of 10% [5,6]-fullerene-C₆₀ in 1-methyl-1-propyl-pyrrolidiniumbis(trifluoromethylsulfonyl)imide was applied onto the second graphite felt, until it was fully saturated with the suspension and could not take on any further suspension. The cavity of the on two sides open body was filled subsequently with 1-methyl 1-propyl-pyrrolidiniumbis(trifluoromethylsulfonyl)imide, whereby the 1-methyl-1-propyl-pyrrolidiniumbis(trifluoromethylsulfonyl)imide acts as the electrolyte. The on two sides open body is an embodiment of the electrochemical half-cell of the electrochemical energy storage and/or energy conversion device of the invention. Subsequently, the second on one-sided open body was attached force-fit, in particular liquid-tight, on one side, attached at the side via the open side delimiting PVC frame to the separator of the first half-cell. The electrical contact of the first and the second electrochemical half-cell was carried out by a first copper plate on the first graphite plate and a second copper plate on the second graphite plate. The two electrochemical half-cells were then electrically connected via the first copper plate and the second copper plate with an electrical conductor of the current density of 0.3 mA/cm².

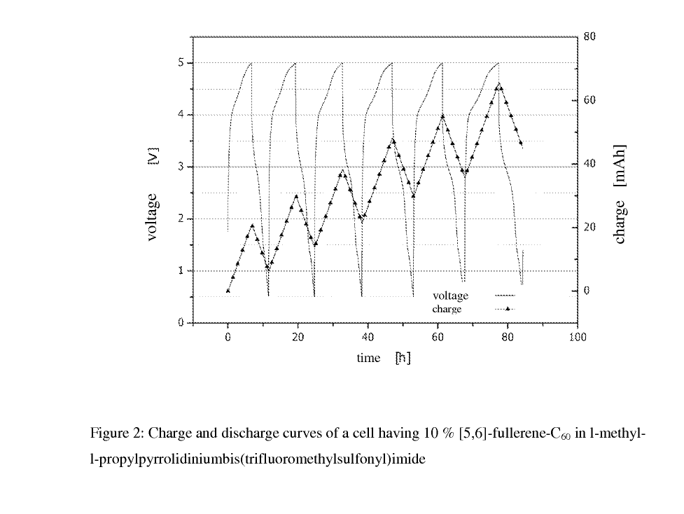

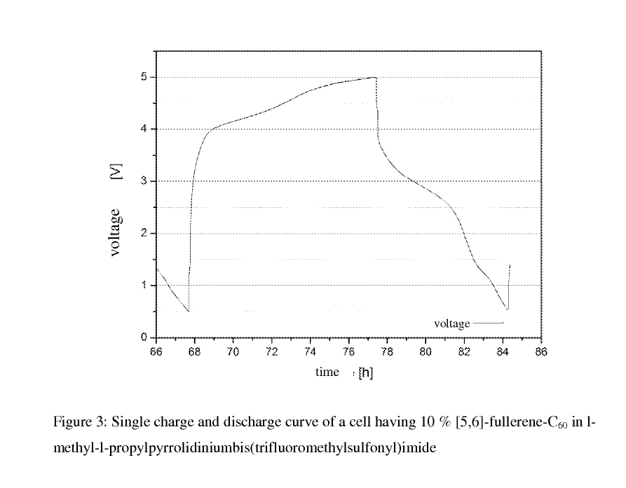

As shown in FIGS. 2 and 3 the final charge voltage of the so constructed electrochemical energy storage and/or energy conversion device, is about 5 V and the final discharge voltage is about 0.5 V. In a charging process, the electrochemical energy storage and/or energy conversion device polarizes first uniformly up to a voltage of about 4 V. Next, slowing down of polarization of the electrochemical energy storage and/or energy conversion device occurs until the final charge voltage is reached. After charging, the terminal voltage falls within 10 minutes to a value of about 4.4 V and then within another 10 minutes to a value of about 4.3V. Then, the electrochemical energy storage and/or energy conversion device was discharged. In doing so, the cell polarized in less than 1 minute to a value of about 3.9 V and then within 2.5 hours to a value of about 2.8 V, and then within 3.5 hours to a value of about 1.25 V. The charge and discharge curves show a behavior that corresponds to the Nernst equation with two electronic transitions.

1. Electrochemical half-cell, comprising an active anode and/or cathode material having at least one fullerene as electrochemically active compound.

2. Electrochemical half-cell according to claim 1, wherein the fullerene is selected from the group consisting of [5,6]-fullerene-C₆₀, [5,6]-fullerene-C₇₀, fullerene-C₇₆, fullerene-C₇₈, fullerene-C₈₀, fullerene-C₈₂, fullerene-C₈₄, fullerene-C₈₆, fullerene-C₉₀ or mixtures thereof.

3. Electrochemical half-cell according to claim 1, wherein the fullerene is present in the form of a suspension having an ionic liquid.

4. Electrochemical half-cell according to claim 3, wherein the ionic liquid is selected from the group consisting of 1-butyl-3-methyl-imidazolium-chloride, 1-butyl-3-methyl-imidazolium-hexafluorphosphate, 1-butyl-3-methyl-imidazolium-tetrafluorborate, 1-butyl-3-methyl-imidazolium-trifluormethanesulfonate, 1-butyl-1-methyl-pyrrolidinium-bis(trifluoromethylsulfonyl)imide, butyl-trimethylammonium-bis(trifluoromethylsulfonyl)imide, cholin-dihydrogenphosphate, ethylammoniumnitrate, 1-ethyl-3-methyl-imidazolium-bromide, 1-ethyl-3-methyl-imidazolium-dicyanamide, 1-ethyl-3-methyl-imidazolium-ethylsulfate, 1-ethyl-3-methyl-imidazolium-methanesulfonate, 1-hexyl-3-methyl-imidazoliumchloride, 1-hexyl-3-methyl-imidazolium-hexafluorophosphate, 1-hexyl-3-methyl-imidazolium-tetrafluoroborate, 1-methyl-3-octyl-imidazolium-hexafluorophosphate, 1-methyl-3-octyl-imidazolium-tetrafluoroborate, 1-methyl-3-propyl-imidazolium-iodide, 1-methyl-1-propyl-piperidinium-bis-(trifluoromethylsulfonyl)-imide, triethylsulphonium-bis(trifluoromethylsulfonyl)imide or mixtures thereof.

5. Electrochemical half-cell according to claim 1, comprising a suspension having 0.1 to 99.9 wt. %, fullerene, based on the total weight of the suspension.

6. Electrochemical half-cell according to claim 1, having an active and/or anode material, which can absorb and/or emit up to 6 electrons.

7. Electrochemical energy storage and/or energy conversion device comprising at least two electrochemical half-cells, wherein:
(i) a first electrochemical half-cell includes
(a) an active anode material
(b) a first electrolyte and
(c) a first electrode, and
(ii) a second electrochemical half-cell includes
(a) an active cathode material
(b) a second electrolyte and
(c) a second electrode, and
(iii) the electrolyte of the first electrochemical half-cell and the electrolyte of the second electrochemical half-cell are in contact via a separator, and
(iv) the first electrochemical half-cell and/or the second electrochemical half-cell include independently from each other, an active anode and/or cathode material, which comprises at least one fullerene as electrochemically active compound.

8. Electrochemical energy storage and/or energy conversion device according to claim 7, wherein the active anode and/or cathode material of the first and/or the second electrochemical half-cell comprises a suspension having at least one fullerene.

9. Electrochemical energy storage and/or energy conversion device according to claim 7, wherein the first and the second electrode comprises at least one carbonaceous material.

10. Electrochemical energy storage and/or energy conversion device according to claim 9, wherein the carbonaceous materials comprise sheets.

11. Electrochemical energy storage and/or energy conversion device according to claim 10, wherein the sheets comprise woven or non-woven fabric sheets containing carbon fibers.

12. Method for producing an electrochemical half-cell, comprising: providing a suspension having at least one fullerene as an electrochemically active compound.

13. (canceled)
